(19) United States
(12) Patent Application Publication
(10) Pub. No.: US 2022/0339898 A1
(43) Pub. Date: Oct. 27, 2022

(54) METHOD AND SYSTEM FOR REMOVING A SEALING AGENT FROM THE SURFACE OF AN INNER CAVITY OF AN END-OF-USE PNEUMATIC TIRE

(71) Applicant: Bridgestone Europe NV/SA [BE/BE], Zaventem (BE)

(72) Inventors: Roberto Pontone, Roma (IT); Cristian Capaldi, Roma (IT); Luca Camosi, Roma (IT)

(21) Appl. No.: 17/620,784

(22) PCT Filed: Jun. 22, 2020
(86) PCT No.: PCT/IB2020/055862

§ 371 Date: Dec. 20, 2021

(30) Foreign Application Priority Data
Jun. 24, 2019 (IT) 102019000009930

(51) Int. Cl. B29D 30/00; B08B 7/00; B08B 1/02; B08B 15/04; B29B 17/02; B29B 17/04; B24B 5/18

(52) U.S. Cl. CPC B29D 30/0061; B08B 7/0092; B08B 1/02; B08B 15/04; B29B 17/02; B29B 17/04; B24B 5/185; B29B 2017/0203; B29B 2017/0217; B29B 2017/0416; B29B 2017/0484

(57) ABSTRACT

The invention relates to a method and a system for the processing of an end-of-use pneumatic tyre that is provided with an inner lining (SAL) layer manufactured with a sealing agent intended to seal any punctures and at least partially applied to the surface of an inner cavity (2) of the end-of-use pneumatic tyre; the system (1) comprises an applicator device (6), which is provided with at least one nozzle (13) which dispenses a cryogenic fluid, preferably liquid nitrogen, upon the (SAL) layer of sealing agent in such a way that the (SAL) layer of sealing agent reaches the solid state; a device (14) for the removal of the (SAL) layer of solid sealing agent that is provided with a tool (16) for removing the (SAL) layer of solid sealing agent by means of mechanical abrasion; and a circuit (17) for suctioning the solid sealing agent removed by the tool (16).

### TECHNICAL SECTOR

The present invention relates to a method and a system for removing a sealing agent from the surface of an inner cavity of an end-of-use pneumatic tire.

### PRIOR ART

As known, a pneumatic tire comprises a toroidal carcass, which has two annular beads and which supports an annular tread. A tread belt is interposed between the carcass and the tread which comprises a number of tread plies. The carcass supports a pair of sidewalls arranged between the tread and the beads. An innerliner is arranged within the body ply which is airtight, constitutes an inner lining and has the function of retaining the air within the pneumatic tire in order to maintain the inflation pressure of the pneumatic tire itself over time.

In recent years pneumatic tire development has been directed towards pneumatic tires with an inner lining that is manufactured with a sealing agent that is intended to seal any punctures. Typically, the sealing agent has a high viscosity in order to ensure both the sealing action in relation to any punctures and the stability thereof within the inner cavity regardless of the conditions of the pneumatic tire.

The sealing agent is applied to a pre-vulcanized pneumatic tire and preferably to the innerliner within the area of the pneumatic tire that comes into contact with the road (or the area of the pneumatic tire wherein punctures can potentially occur). In particular, the sealing agent is applied at the tread and at least partially at the sidewalls.

Furthermore, as is known, due to the large market volumes for pneumatic tires and the complex recycling process thereof, used pneumatic tires are today among the greatest sources of waste within Europe. The objectives set by the ETRMA envisage a reduction in the number of pneumatic tires that are abandoned in landfills, such that in the coming years almost all end-of-use pneumatic tires will be processed for the production of energy and/or secondary materials.

End-of-use pneumatic tires, whereupon a sealing agent layer has been applied, cannot however be recycled and must be consigned to thermal demolition, this is because the sealing agent would cause irreparable damage to those shredding machines normally employed in the disposal cycles for end-of-use pneumatic tires.

The utility model CN2027652668U describes a machine for cleaning the surface of a pneumatic tire using high pressure water jets.

The utility model CN207806024U and the patent application CN108311455A describe a machine for washing and then drying a pneumatic tire.

The patent application EPO3085523A1 describes a plant for applying a layer of self-sealing material to the inner surface of a pneumatic tire.

### DESCRIPTION OF THE INVENTION

The aim of the present invention is therefore to provide a system for removing a sealing agent from the surface of an inner cavity of an end-of-use pneumatic tire that is free from the disadvantages of the state of the art and that is, in particular, easy and inexpensive to manufacture.

A further aim of the present invention is to provide a method for removing a sealing agent from the surface of an inner cavity of an end-of-use pneumatic tire that is free from the disadvantages of the state of the art and that is, in particular, easy and inexpensive to implement.

According to the present invention, a method and a system are provided for removing a sealing agent from the surface of an inner cavity of an end-of-use pneumatic tire according to that set forth within the appended claims.

### BRIEF DESCRIPTION OF THE DRAWINGS

The present invention is now described with reference to the attached drawings, which illustrate several non-limiting exemplary embodiments, wherein:

FIG. 1 is a schematic view, with parts removed for clarity, of a device for applying a cryogenic fluid of a system manufactured in accordance with the present invention; and

FIG. 2 is a schematic view, with parts removed for clarity, of a device for removing a layer of sealing agent, of a system manufactured in accordance with the present invention.

### PREFERRED EMBODIMENTS OF THE INVENTION

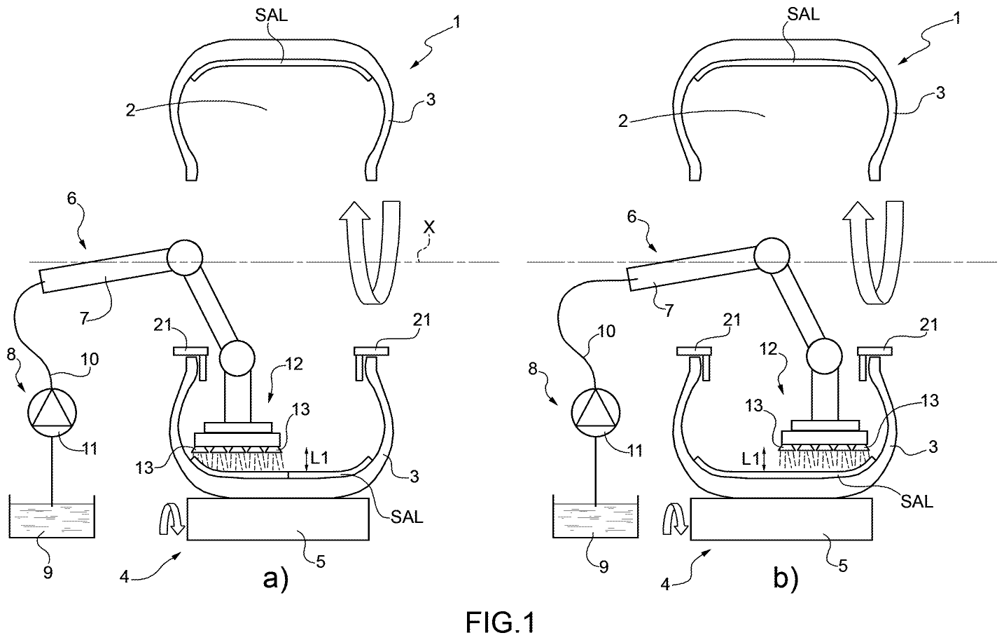

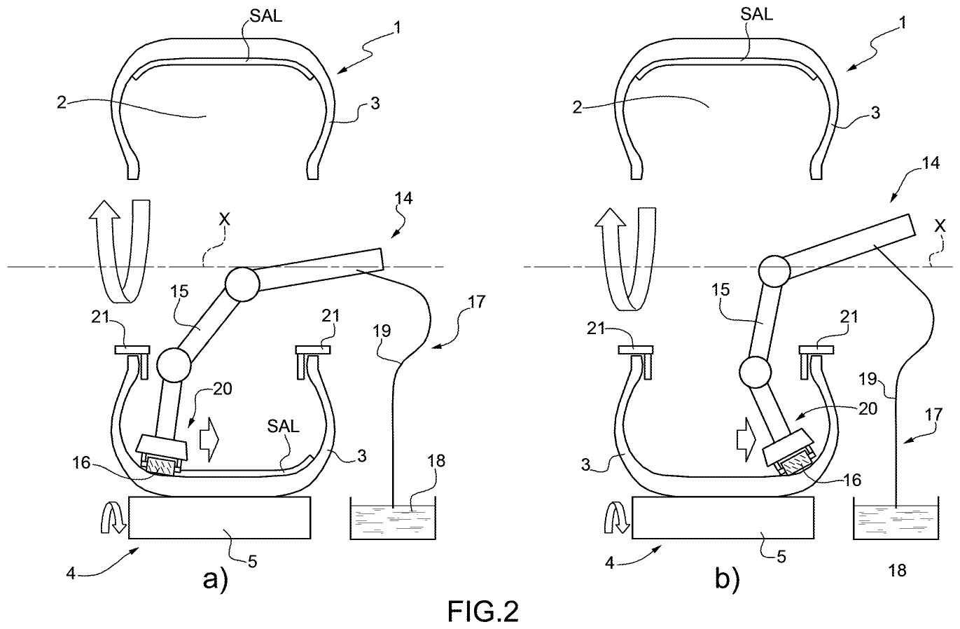

With reference to FIGS. 1 and 2, number 1 indicates a system in the entirety thereof for processing an end-of-use pneumatic tire 3 that is provided with an inner lining SAL layer manufactured with a sealing agent that is intended to seal any punctures. The system 1 is designed to apply a cryogenic fluid to the SAL layer of sealing agent, that is in turn applied to the surface of an inner cavity 2 of the end-of-use pneumatic tire 3 and, subsequently, for removing the sealing agent layer from the surface of said inner cavity 2.

The end-of-use pneumatic tire 3 is arranged upon a support 4 that is predisposed for locking the end-of-use pneumatic tire 3 and bringing it into rotation about the central axis X thereof via motorized rollers 5. The support 4 is designed to bring the pneumatic tires 3 into rotation at a substantially constant speed and preferably between 1 and 15 m/min. Preferably, the end-of-use pneumatic tire 3 is housed within the support 4 in such a way as to prevent any lateral translation of the pneumatic tire 3 itself during the rotational movement about the axis X.

The system 1 also comprises a device 6 for applying the cryogenic fluid that is conveniently implemented by means of a robot equipped with a movable arm 7 and intended to coat the SAL layer of sealing agent with the cryogenic fluid in a uniform manner. The applicator device 6 is designed to be movable in such a way as to be moved and arranged in an application position within the inner cavity 2 directly facing the SAL layer of sealing agent. In the application position, the applicator device 6 is arranged at a determined distance L1 (not zero in order to implement an application without contact) from the SAL layer of sealing agent.

The applicator device 6 is intended to uniformly cover the SAL layer of sealing agent with the cryogenic fluid by means of a reciprocating movement between the two lateral ends of the inner cavity 2; in particular, the arm 7 moves within a plane that is substantially perpendicular to the equatorial plane of the end-of-use pneumatic tire 3. The combination of the rotation of the end-of-use pneumatic tire 3 about the axis X and the movement of the arm 7 produces an application of the cryogenic fluid with a helical progression. More specifically, the applicator device 6 is intended to apply the cryogenic fluid exclusively within the portion of the end-of-use pneumatic tire 3 that is provided with the SAL layer of sealing agent and intended to come into contact with the asphalt (in other words, at the tread and, at least partially, at the sidewalls of the end-of-use pneumatic tire 3).

The applicator device 6 is connected to a circuit 8 supplying the cryogenic fluid and comprising a tank 9, preferably made of a metallic material and containing the cryogenic fluid, a conduit 10 that originates from the tank 9 and that is in hydraulic communication with the applicator device 6, and a pumping device 11 that draws the cryogenic fluid from the tank 9 and feeds it under pressure to the applicator device 6.

According to a preferred variant, the applicator device 6 is implemented by means of a dispensing head 12 at an axial end of the movable arm 7 and which supports at least one nozzle 13 in order to execute the application of the cryogenic fluid in a contactless manner. According to a preferred variant, the dispensing head 12 supports a plurality of nozzles 13 having respective axes that are parallel to one another and perpendicular to the axis X.

In the application position, each nozzle 13 directly faces the SAL layer of sealing agent and is arranged at a distance L1 from the SAL layer of sealing agent.

The automatic movement of the motorized rollers 5 that bring the end-of-use pneumatic tire 3 into 360° rotation about the axis X makes it possible to uniformly apply the cryogenic fluid to the entire SAL layer of sealing agent.

According to a preferred variant, the cryogenic fluid employed is liquid nitrogen (N₂), having a boiling point of −195.82° C. According to a further variant, the cryogenic fluid employed is dry ice (CO₂), having a boiling point of −78° C.

The cryogenic fluid applied to the SAL layer of sealing agent in the semi-fluid state produces a lowering of the temperature of the SAL layer of sealing agent itself. When the end-of-use pneumatic tire 3 has completed a series of 360° rotations about the axis X, the SAL layer of sealing agent coated with cryogenic fluid has hardened, thereby reducing the elasticity and viscosity thereof. In other words, the SAL layer of sealing agent, at the temperature of the cryogenic fluid, appears in the solid state.

Finally, the system 1 comprises a device 14 for the removal of the SAL layer of solid sealing agent which is conveniently implemented by means of a robot equipped with a movable arm 15. The removal device 14 is implemented movable in such a way that it can be moved into and arranged in a working position inside the inner cavity 2 directly facing and in contact with the SAL layer of solid sealing agent.

The removal device 14 is intended to remove the SAL layer of solid sealing agent using mechanical abrasion by means of a reciprocating movement between the two lateral ends of the inner cavity 2; in particular, the movable arm 15 moves within a plane that is substantially perpendicular to the equatorial plane of the end-of-use pneumatic tire 3. The combination of the rotation of the end-of-use pneumatic tire 3 about the axis X and the movement of the arm 15 leads to removal with a helical progression, which makes it possible to completely remove the SAL layer of solid sealing agent.

According to a preferred variant, the removal device 14 is implemented by means of a head arranged at an axial end of the movable arm 15 and which supports a tool, in particular a grinding wheel, 16 in order to implement the removal/abrasion of the SAL layer of solid sealing agent.

A suction circuit 17 for the sealing agent, removed by means of the removal device 6, is connected to the removal device 14. The suction circuit 17 is implemented by directing a flow of particles/dust, produced by the action of the grinding wheel 16, onto the SAL layer of solid sealing agent to the outside of the inner cavity 2 and of the pneumatic tire 3. More specifically, the suction circuit 17 comprises a tank 18 for the collection of the sealing agent, a suction pump (not shown) which is connected to a suction head 20 via a conduit 19 which originates from the suction head 20 and flows into the tank 18. The suction head 20 draws the sealing agent removed from the inner cavity 2 and feeds it to the tank 18 via the conduit 19. The suction head 20 is movable, with a reciprocating movement between the two lateral ends of the inner cavity 2; in particular the suction head 20 moves within a plane that is substantially perpendicular to the equatorial plane of the end-of-use pneumatic tire 3.

Preferably, the suction head 20 is formed integrally with the removal device 14; in other words, the head arranged at the axial end of the movable arm 15, which supports the grinding wheel 16, is also equipped with the suction head 20. The suction head 20 is preferably arranged in proximity to the grinding wheel 16.

It is important to be able to eliminate/suction the SAL layer of solid sealing agent removed by the grinding wheel 16 as long as it is in the solid state in order to prevent it from returning to the semi-fluid state following an increase in the temperature thereof and, as a result, having an elasticity and a viscosity such as to render the SAL layer of sealing agent difficult to machine/manipulate.

The combination of the automatic movement of the support 4, which brings into 360° rotation the end-of-use pneumatic tire 3 about the axis X, and the movement of the arm 15 makes it possible to remove the entire SAL layer of solid sealing agent.

The system 1 is preferably housed within an isolated chamber in order to maintain the lowest possible temperatures.

According to one variant, the applicator device 6 and the removal device 14 can be accommodated on a common arm (that is to say, according to this variant, the arm 7 and the arm 15 may coincide).

Hereinafter there will be described the method of operation of the system 1, which includes, in succession, the following steps:
an operator or, alternatively, an automatic manipulator arranges the end-of-use pneumatic tire 3 on the support 4 and locks it by means of sidewalls 21 in such a way as to prevent any lateral translation of the pneumatic tire 3 itself;
in response to a given operator command, the applicator device 6 is placed in the application position while being inserted into the interior of the cavity 2 and arranging itself at the distance L1 from the SAL layer of sealing agent;
the application of the cryogenic fluid is started by means of the dispensing head 12 (in particular, by means of the nozzles 13) while the end-of-use pneumatic tire 3 is brought into rotation about the axis X by the motorized rollers 5; at the same time, the arm 7 moves with a reciprocating movement between the two lateral extremities of the inner cavity 2;
once an interval of time of a predetermined duration, that can be varied as a function of the type of cryogenic fluid employed, has elapsed, the application of cryogenic fluid stops;
the motorized rollers 5 are stopped and the movement of the arm 7 between the two lateral ends of the inner cavity 2 is stopped;
the applicator device 6 is extracted from the inner cavity 2;
the removal device 14 is inserted into the inner cavity 2;
once an interval of time from the start of the application of the cryogenic fluid, that is of predetermined duration, and variable as a function of the type of cryogenic fluid employed, has elapsed, the grinding wheel 16 is placed in contact with the sealing agent layer in order to begin the removal;
the end-of-use pneumatic tire 3 is again brought into rotation about the axis X by the motorized rollers 5, the arm 15 simultaneously moves with a reciprocating movement between the two lateral ends of the inner cavity 2, while the grinding wheel 16 implements the abrasion of the SAL layer of solid sealing agent;
during the rotation of the end-of-use pneumatic tire 3 about the axis X and simultaneously with the action of the grinding wheel 16, the suction element 20, that draws the SAL layer of solid sealing agent suctioned from the inner cavity 2 and feeds it to the tank 18, is activated;
at the conclusion of the abrasion and suction of the SAL layer of solid sealing agent (when the end-of-use pneumatic tire 3 has completed a series of 360° rotations in order to obtain the helical progression), the 5 motorized rollers are stopped and the movement of the arm 15 between the two lateral ends of the inner cavity 2 is stopped;
the removal device 14 is extracted from the inner cavity 2;
an operator or, alternatively, an automatic manipulator removes the sidewalls 21 and extracts the end-of-use pneumatic tire 3 from the support 4.

The advantages of the system 1 described in the preceding discussion are evident. In particular, the use of the applicator and removal device 6, 14 makes it possible to efficiently remove the entire SAL layer of sealing agent from the end-of-use pneumatic tire 3, which can then be recycled and not consigned to thermal demolition.

1-10. (canceled)

11. A system for treatment of an end-of-use pneumatic tire that is provided with an inner lining layer, implemented with a sealing agent at least partially applied to a surface of an inner cavity of the pneumatic tire, the system comprising:
an applicator device comprising at least one nozzle at an axial end which dispenses a cryogenic fluid for uniformly coating the inner lining layer of sealing agent in such a way that the inner lining layer of sealing agent reaches a solid state;
a removal device comprising at least one tool configured to remove the inner lining layer of solid sealing agent by mechanical abrasion; and
a suctioning circuit configured to direct a flow of particles/dust produced by the tool acting upon the inner lining layer of solid sealing agent to an outside of the inner cavity via a generated suction.

12. The system of claim 11, wherein the cryogenic fluid dispensed by the applicator device comprises liquid nitrogen.

13. The system of claim 11, wherein the applicator device and the removal device are accommodated on a common movable arm having the at least one nozzle and the at least one tool.

14. The system of claim 11, wherein the applicator device comprises a first movable arm having the at least one nozzle and the removal device comprises a second movable arm having the at least one tool.

15. The system of claim 14, wherein the first arm is movable between two lateral ends of the inner cavity and is arranged within the inner cavity in such a way that the at least one nozzle is located at a non-zero distance from the inner lining layer of sealing agent.

16. The system of claim 14, wherein the first movable arm comprises a plurality of nozzles at one axial end thereof, said plurality of nozzles having respective axes that are parallel to one another and perpendicular to an axis of symmetry of the end-of-use pneumatic tire.

17. The system of claim 14, wherein the suction circuit comprises a tank for collection of the sealing agent and a suction pump which is connected via a conduit to a suction head which is movable between two lateral ends of the inner cavity.

18. The system of claim 17, wherein:
the suction head is integrally formed with the suction device; and
the second arm is provided at an axial end of both said tool and of the suction head.

19. The system of claim 11, further comprising a support predisposed for bringing the end-of-use pneumatic tire into rotation about a central axis thereof via motorized rollers and to lock the end-of-use pneumatic tire via sidewalls such as to impede lateral translation thereof.

20. A method for treatment of an end-of-use pneumatic tire that is provided with an inner lining layer, manufactured with a sealing agent to seal punctures and at least partially applied to a surface of an inner cavity of the pneumatic tire, the method comprising steps of:
dispensing a cryogenic fluid to uniformly coat the inner lining layer of sealing agent in such a way that the inner lining layer of sealing agent reaches a solid state;
removing the inner lining layer of solid sealing agent via mechanical abrasion, after a time interval having a predetermined duration from a start of the dispensing step; and
suctioning a flow of particles/dust produced by the removing step such as to direct said flow to an outside of the inner cavity.

21. The method of claim 20, wherein the dispensed cryogenic fluid comprises liquid nitrogen.

22. The method of claim 20, wherein the removing step is started once a time interval has elapsed, said time interval having a duration which is variable as a function of a type of cryogenic fluid employed from a start of the dispensing step.

23. The method of claim 20, further comprising setting in rotation the end-of-use pneumatic tire about an axis of symmetry thereof.

24. The method of claim 20, wherein the suctioning step is implemented simultaneously with the removing step.
